(19) United States
(12) Patent Application Publication
(10) Pub. No.: US 2010/0112174 A1
(43) Pub. Date: May 6, 2010

(54) LOW CALORIE SWEETENER COMPOSITIONS

(75) Inventors: Timothy A. Christensen, Maple Grove, MN (US); Frans Sarnell, Zuiddorpe (NL)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/521,152

(22) PCT Filed: Dec. 28, 2007
(86) PCT No.: PCT/US07/26396

§ 371 Date: Dec. 28, 2009

Related U.S. Application Data
(60) Provisional application No. 60/877,525, filed on Dec. 28, 2006.

(51) Int. Cl. A23L 1/236; A23L 1/0522; A23G 3/34

(52) U.S. Cl. 426/548

(57) ABSTRACT

The invention is directed to low calorie sweetener compositions. In some embodiments, the sweetener compositions comprise: (a) about 5 wt. % to about 40 wt. % erythritol; (b) about 0 wt. % to about 30 wt. % sorbitol; (c) about 0 wt. % to about 50 wt. % of an ingredient selected from the group consisting of isomalt, maltitol, or a mixture thereof; (d) about 5 wt. % to about 40 wt. % polydextrose; and (e) about 5 wt. % to about 40 wt. % resistant starch. In other embodiments, the sweetener compositions comprise: (a) about 5 wt. % to about 40 wt. % erythritol; (b) up to about 68 wt. % of an ingredient selected from isomalt, maltitol, sorbitol, or a mixture thereof; (c) about 5 wt. % to about 40 wt. % of an ingredient selected from polydextrose, resistant maltodextrin, or a mixture thereof. Embodiments of the low calorie sweetener compositions display improved gastrointestinal tolerance when consumed by humans.

### CROSS-REFERENCE TO RELATED APPLICATIONS

This application claims the benefit of PCT/US2007/026396, filed 28 Dec. 2007, which application claims priority to U.S. Provisional Application Ser. No. 60/877,525, filed 28 Dec. 2006, the disclosures of which are incorporated herein by reference.

### BACKGROUND

Low calorie sweeteners have gained widespread use because of the demand for low calorie foods and beverages that mimic the taste of higher calorie food and beverages that are prepared with sugar. However, many low calorie sweetener compositions cause gastrointestinal intolerance when consumed in typical amounts. Examples include sugar alcohols such as erythritol, maltitol, isomalt, sorbitol, mannitol, and xylitol; and low digestibility oligosaccharides. Gastrointestinal intolerance typically includes undesirable symptoms such as gastrointestinal rumbling, abdominal cramping, gas, bloating, excessive flatulence, loose stools, and diarrhea.

In view of the undesirable effects resulting from certain low calorie sweeteners, what is desired is a low calorie sweetener composition that is suitable for use in foods (e.g., baked goods) and beverages that has improved gastrointestinal tolerance when consumed by humans.

### SUMMARY

The invention is directed to low calorie sweetener compositions. Embodiments of the low calorie sweetener compositions of the invention have improved gastrointestinal tolerance in humans. For example, embodiments of the low calorie sweetener of the invention have improved gastrointestinal tolerance when compared to maltitol. Gastrointestinal tolerance can be measured, for example, using human studies where test foods comprising the sweetener to be tested and a comparative sweetener are consumed by human subjects in controlled fashion, and the human subjects rate the foods for gastrointestinal effects including, for example, gastrointestinal rumbling, abdominal cramping, gas, bloating, excessive flatulence, loose stools, and diarrhea.

In one aspect, the invention is directed to low calorie sweetener compositions comprising: (a) about 5 wt. % to about 40 wt. % erythritol; (b) about 0 wt. % to about 30 wt. % sorbitol; (c) about 0 wt. % to about 50 wt. % of an ingredient selected from the group consisting of isomalt, maltitol, or a mixture thereof; (d) about 5 wt. % to about 40 wt. % polydextrose; and (e) about 5 wt. % to about 40 wt. % resistant starch.

In preferred embodiments of the invention, the low calorie sweetener compositions of the first aspect comprise: (a) about 25 wt. % to about 35 wt. % erythritol; (b) about 10 wt. % to about 20 wt. % sorbitol; (c) about 25 wt. % to about 30 wt. % isomalt, maltitol, or a mixture thereof; (d) about 5 wt. % to about 20 wt. % resistant starch; and (e) about 10 wt. % to about 20 wt. % polydextrose.

In a second aspect, the invention is directed to low calorie sweetener compositions comprising: (a) about 5 wt. % to about 40 wt. % erythritol; (b) up to about 68 wt. % of an ingredient selected from isomalt, maltitol, sorbitol, or a mixture thereof; (c) about 5 wt. % to about 40 wt. % of an ingredient selected from polydextrose, resistant maltodextrin, or a mixture thereof. In a preferred aspect, the low calorie sweetener comprises about 29 wt. % polydextrose, about 57% maltitol, and 14% erythritol.

Low calorie sweetener compositions of the invention may further comprise one or more high intensity sweeteners, such as acesulfame potassium and neotame.

In yet another aspect, the invention is directed to foods, such as baked goods and beverages that comprise the low calorie sweetener compositions of the invention.

### DETAILED DESCRIPTION

In one aspect, the invention is directed to low calorie sweetener compositions. Embodiments of the low calorie sweetener compositions of the invention have improved gastrointestinal tolerance in humans.

The ingredients making up the sweetener compositions of the invention are described in more detail below.

### Erythritol:

Sweetener compositions of the invention comprise erythritol. Erythritol or tetrahydroxybutane is a tetrahydric polyol or sugar alcohol that has the empirical formula C₄H₁₀O₄ and the structural formula CH₂OH—CHOH—CHOH—CH₂OH. Erythritol has a low caloric content of about 0.2 calories/gram.

Erythritol has a sweetness level that is about 75% that of sucrose. Due to its small molecular size, erythritol behaves differently than other polyols that are used as sugar substitutes. Erythritol is absorbed very quickly in the small intestine and is not subject to metabolic conversion in the body. Because of this, erythritol has a higher digestive tolerance than other sugar alcohols.

Erythritol is typically manufactured synthetically by fermenting glucose with special yeast strains in appropriate aqueous nutrient media, or by treating an aqueous alkali carbonate solution of 2-buten-1,4-diol with chlorine, and saponifying the resulting chlorohydrin. Erythritol is typically provided as a white crystalline powder that has a melting point of about 120° C.

Erythritol is present in the sweetener compositions of the invention in an amount ranging from about 5 wt. % to about 40 wt. %. In more preferred embodiments, erythritol is present in an amount ranging from about 25 wt. % to about 35 wt. %. Erythritol may be obtained commercially under the trade designation “ERIDEX” (from Cargill Specialty Sweeteners division of Cargill, Incorporated).

### Sorbitol:

In some embodiments, the sweetener compositions of the invention comprise sorbitol. Sorbitol is a sugar alcohol that has the formula C₆H₈(OH)₆. Sorbitol is obtained by reducing the aldehyde group in glucose to form an alcohol group. Sorbitol is a nutrituve sweetener providing about 2.6 calories/gram. Sorbitol has a sweetness level that is about 60% that of sucrose. Because it metabolizes slowly, ingestion of large amounts of sorbitol may in some instances lead to gastrointestinal intolerance such as abdominal pain, gas, and diarrhea.

Sorbitol may be obtained commercially under the trade designation “SORBIDEX” (from Cerestar division of Cargill, Incorporated).

### Isomalt:

In some embodiments, the sweetener compositions of the invention comprise isomalt. Isomalt is a sugar alcohol that comprises two components: 1,6-glucopyranosyl-D-sorbitol (GPS) and 1,1-glucopyranosyl-D-mannitol (GPM), in a 1:1 ratio.

Isomalt is an odorless, white, crystalline substance which typically contains about 5% water. Isomalt has about 2 calories/gram. Like most sugar alcohols, ingestion of large amounts of isomalt may in some instances lead to gastrointestinal intolerance such as abdominal pain, gas, and diarrhea. Isomalt is typically derived from sucrose by enzymatic conversion into isomaltulose, which is then hydrogenated to obtain the two component mixture of GPS and GPM.

Isomalt may be obtained commercially under the trade designation “ISOMALTIDEX” (from Cerestar division of Cargill, Incorporated).

### Maltitol:

In some embodiments, the sweetener compositions of the invention comprise maltitol. Maltitol is a polyol or sugar alcohol type sweetener. Maltitol is disaccharide consisting of glucose and sorbitol. As a sweetener, maltitol has about 90% of the sweetness of sugar and has nearly identical properties, except for browning.

Maltitol may be manufactured by the catalytic hydrogenation of high maltose corn syrup, which transforms the maltose to the sugar alcohol maltitol. It is often provided in as a syrup, or in solid form as a white crystalline powder. Maltitol powders and syrups typically comprise about 50 wt. % to 90 wt. % maltitol.

Maltitol provides about 2.1 calories/gram, approximately 75% that of sugar. Being a sugar alcohol, maltitol is known to cause gastric distress, particularly if consumed in large quantities.

When present, maltitol is typically present in the sweetener compositions of the invention in an amount up to about 50 wt. %. In preferred embodiments, maltitol is present in an amount ranging from about 15 wt. % to about 45 wt %. Maltitol may be obtained commercially under the trade designation “MALTISORB” (from Roquette); “MALTISWEET” (from SPI Polyols); and “MALTIDEX” (from Cargill Sweetness Solutions division of Cargill, Incorporated).

### Polydextrose:

In some embodiments, the sweetener compositions of the invention comprise polydextrose. Polydextrose is a non-sweet, water-soluble, low-calorie, bulking agent that can provide both bulk and texture properties that are similar to sugar when used in sweetener compositions.

Chemically, polydextrose is a randomly bonded highly branched glucose polymer. Polydextrose can be synthesized by the acid catalyzed condensation of glucose. In many embodiments, polydextrose is made from glucose, sorbitol, and citric acid. Synthesis of polydextrose is described, for example, in U.S. Pat. Nos. 3,766,165 and 3,876,794. Polydextrose provides about 1 calorie/gram.

Polydextrose can be obtained commercially under the trade designation “LITESSE” (from Danisco, Company) and StaLite III (from Tate and Lyle).

### Resistant Starch:

In some embodiments, the sweetener compositions of the invention comprise resistant starch. Resistant starch is a special form of starch that resists digestion in the small intestine. Sarch is a complex carbohydrate that is made up of two types of polysaccharide molecules: amylase and amylopectin. Starch is predominately digested in the small intestine because of the action of the enzyme alpha-amylase. Through certain processing techniques, conventional starch can be transformed into resistant starch, a type of starch that is resistant to enzymatic hydrolysis in the small intestine.

Resistant starch can be classified into four general types depending on the mechanism of its digestive resistance. RS1 is a physically inaccessible starch due to entrapment of granules within a protein matrix or within a plant cell wall. Examples include partly milled grains, seeds, and legumes. RS2 is a granular starch that resists digestion by pancreatic alpha-amylase. Examples include native uncooked potato starch and green banana. RS3 is a non-granular retrograded or crystalline starch. Examples include cooled-cooked potato, bread, and breakfast cereals. RS4 is chemically modified resistant starch that has some linkages other than alpha-1,4- and alpha-1,6-D-glucosidic bonds.

Various methods have been reported for producing resistant starch. For example, U.S. Pat. No. 5,593,503 describes a method of making a granular resistant starch. U.S. Pat. Nos. 5,281,276 and 5,409,542 describe methods of making resistant starches of the RS3 type from high amylose starches. U.S. Pat. No. 6,043,229 discloses a partially degraded and retrograded resistat starch.

In some embodiments, the sweetener compositions of the invention comprise a RS3 type resistant starch. Type RS3 resistant starch may be prepared by enzymatic de-branching of a tapioca maltodextrin and subsequent retrogradation. During retrogradation, slightly hydrolysed amylose (i.e., the linear carbohydrate chain in starch) forms double-helical crystalline structures called crystallites.

A particularly useful RS4 resistant starch is reported in U.S. Pat. No. 5,855,946. These resistant starches are reported to exhibit at least about a 20% resistance to alpha-amylase digestion, as measured using American Association of Analytical Chemists (AOAC) Method 992.16 (1995). In some embodiments, the resistant starches have 35% or greater resistance, and most preferably 50% or greater resistance to alpha-amylase digestion.

The reported starches can be prepared from any type of starting starch (e.g., wheat, corn, oat, rice, tapioca, mung bean, potato or high amylose starches). The cross-linked starches are most preferably phosphorylated to form distarch phosphate diesters and typically contain at least 0.1 wt. % residual phosphorous, and more preferably at least about 0.2 wt. % residual phosphorous. The preferred phosphorylating agent is a mixture of sodium trimetaphosphate (STMP) and sodium tripolyphosphate (STPP) in the presence of sodium chloride or sulfate. Generally, where the mixture is used, it comprises from about 1-20 wt. % STMP (most preferably from about 5-12 wt. % STMP) and from about 0.01-0.2 wt. % STPP (most preferably from about 0.05-0.12 wt. % STPP). Another useful phosphorylating agent is phosphoryl chloride. In addition, other cross-linking agents such adipic acid or epichlorohydrin may also be used.

The RS4 starch of U.S. Pat. No. 5,855,946 may be prepared by reacting a starting (usually native and unmodified) starch in the presence of water and a cross-linking agent under conditions of pH and temperature to yield a modified starch having the desired alpha-amylase digestion properties. The preferred preparation method involves initially forming a slurry of the starting starch in water and adding the cross-linking agent to the slurry. The slurry typically has about 15-60 wt. % starch, and more preferably from about 30-50 wt. % starch. The preferred phosphorylating cross-linker would be STMP alone or a mixture of STMP and STPP. The reaction need be carried out only for a sufficient time to provide the requisite degree of alpha-amylase digestion resistance, for example, a period of about 10 minutes to about 24 hours, more preferably from about 1-3 hours. Where STMP or the STMP/STPP mixture is used as the phosphorylating agent, it is sometimes preferred to add an amount (from about 0.1-20% by weight, based upon the weight of the starting starch taken as 100% by weight) of sodium sulfate or sodium chloride to the slurry. The presence of one of these salts serves to retard gel formation during the reaction and to accelerate the reaction by increasing the base adsorbed by the starch granules.

Useful resistant starch has a dextrose equivalent of about 100. Dextrose equivalent, as used herein, is intended to mean the reducing power of the hydrolysate. Since each starch molecule has one reducing end, DE is inversely related to molecular weight. The DE of anhydrous D-glucose is defined as 100 and the DE of unhydrolyzed starch is almost zero. Maltodextrin typically has a DE of about 5 to 20. Some types of resistant maltodextrin have a DE of about 8 to 12.5.

Useful resistant starch may be obtained commercially under the trade designation “ACTISTAR RT” (from Cargill Texturizing Solutions).

### Resistant Maltodextrin:

In some embodiments, the sweetener compositions of the invention comprise resistant maltodextrin. A resistant maltodextrin is defined as a short chain polymer of glucose that is resistant to digestion in the human digestive system. Suitable resistant maltodextrin is commercially available under the trade designation “FIBERSOL-2” (from Archer Daniels Midland Company, Decatur, Ill.)

### High Intensity Sweetener:

In some embodiments, the sweetener compositions of the invention comprise a natural or synthetic high intensity sweetener. Examples of useful high intensity sweeteners include sucralose (1,6-dichloro-1,6-dideoxy-β-D-fructo-furanosyl 4-chloro-4-deoxy-α-D-galactopyranoside; “SPLENDA” from Tate & Lyle), acesulfame potassium (potassium salt of 6-methyl-1,2,3-oxathiazine-4(3H)-one 2,2-dioxide; (SUNETT” from Nutrinova)), N—[N-(3,3-dimethylbutyl)-L-aspartyl]-L-phenylaniline 1-methyl ester (“NEOTAME” from NutraSweet), aspartame (N-L-a-aspartyl-L-phenylalanine 1-methyl ester (“EQUAL” from Merisant Co.)), saccharin, alitame, cyclamate (Na or K salt of cyclohexanesulfamic acid), monatin (and its salts), monellin, glycyrrhizin (and its salts), thaumatin, stevia, compounds derived from stevia (e.g., rebaudiosides and steviosides), brazzein, neohesperidin dihydrochalcone (NHDC), 3,4-dihydroxybenzylamine (DHBA), lo han guo, or any approved sweeteners potentiator, and the like. Mixtures of high intensity sweeteners may also be used.

When included, a high intensity sweetener is typically incorporated in an amount up to about 0.4 wt. % of the composition, for example, about 0.1 wt. % to about 0.2 wt. %. In some embodiments a combination of two or more high intensity sweeteners is used. For example, a useful combination of high intensity sweeteners is acesulfame potassium and neotame. The use of these two high intensity sweeteners has been found to provide a desirable sweetness profile. Acesulfame potassium tends to provide an initial sweet taste whereas neotame acts to maintain a sweet flavor profile over time. Typically, the weight ratio of acesulfame potassium to neotame in the sweetener composition ranges from about 8:1 to about 16.7:1, more typically ranging from about 9:1 to about 10:1. Based upon the weight of the formulation, the amount of acesulfame potassium typically ranges from about 0.09 wt. % to about 0.18 wt. % and the amount of neotame typically ranges from about 0.006 wt. % to about 0.011 wt. %.

### Sweetener Compositions:

The sweetener compositions of the invention may be utilized for any application where a sugar-free sweetener is desired. For example, the sweetener composition may be used in a food or a beverage. Typical applications of the sweetener composition include baked goods such as breads, cookies, cakes, brownies, and the like; beverages such as coffee and soft drinks; confections such as chocolates, candies, the like; dairy products such as cheesecake, ice cream, smoothies, yogurt, and the like; cereal bars, health bars, protein bars and the like.

The sweetener compositions of the invention may be manufactured in any manner. Typically, the compositions are produced by mixing or dry blending the components making up the sweetener composition.

### Digestive Tolerance:

In many embodiments, the sweetener compositions of the invention have improved gastrointestinal tolerance in humans. For example, the sweetener compositions of the invention have improved gastrointestinal tolerance as compared to maltitol. Gastrointestinal tolerance can be measured, for example, using a randomized, double blind, crossover, repeated measure design protocol, such described in Test Protocol 1 in the Example section of the application. In a representative test, a test food comprising a sweetener to be tested is consumed by human subjects, and the subjects are required to complete a gastrointestinal survey at various intervals, prior to and after, consuming the test food. For example, the human subject may complete the survey at 0 hours (i.e., just prior to consuming the test food), 2 hours, 6 hours, 12 hours, and 24 hours after consuming the test food. The food is then rated at the various time periods for gastrointestinal tolerance as evidenced by gastrointestinal effects such as gastrointestinal rumbling, abdominal cramping, gas/bloating, excessive flatulence, loose stools, and diarrhea. The reduction in one or more of these gastrointestinal effects is evidence of improved gastrointestinal tolerance for the sweetener composition as compared to the comparative sweetener (e.g., maltitol). Typically, improved gastrointestinal tolerance is evidenced by a reduction in more than one gastrointestinal effect for the sweetener composition as compared to the comparative sweetener composition.

The invention will now be described with reference to the following non-limiting Examples.

### EXAMPLES

The objective of the study was to evaluate and compare the gastrointestinal effects of iced cupcakes prepared with a sweetener composition of the invention to an iced cupcake prepared with maltitol and a sweetener comprising resistant maltodextrin.

### Test Protocol 1:

### Study Design and Methods:

The study used a randomized, double-blind, crossover, repeated measure design. Gastrointestinal symptoms were entered into an on-line questionnaire prior to consuming the cupcake and at 2, 6 12 and 24 hours following the consumption of the cupcake. Consumption of the cupcakes took place on Tuesday morning for a consecutive three-week period. Participants were asked to rate the following symptoms: gastrointestinal rumbling, abdominal cramping, abdominal gas/bloating, excessive flatulence and loose stools on a five point scale with the following descriptors: none, mild, moderate, strong and very strong. Diarrhea was recorded as a yes/no response. Differences in scores between the test foods were tested by a Wilcoxon signed-rank test. Statistical analysis was performed by SAS.

### Subjects:

Seventy individual participants were included in the in-house study. The participants were screened by a questionnaire pertaining to general health and gastrointestinal condition. They appeared to be healthy and claimed they did not have a gastrointestinal condition that could potentially interfere with the absorption or toleration of the test foods. None of the participants reported being constipated.

### Materials:

Three sweetener compositions were evaluated. Sweetener 1 was an embodiment of the present invention. Comparative Sweetener A consisted of 100% maltitol. Comparative Sweetener B was a comparative sweetener composition comprising resistant maltodextrin.

### Sweetener Formulation 1

| Ingredient | Percent Weight (%) |
|---|---|
| Sorbidex 16616 | 15.00 |
| Eridex 16961 | 30.00 |
| Isomaltidex 165A3 | 29.86 |
| Sta-Lite III Polydextrose | 15.00 |
| Actistar RT 75330 | 10.00 |
| Ace K | 0.1321 |
| Neotame | 0.0079 |
| Total | 100.00 |

### Comparative Sweetener A:

100 wt. % Maltitol (Roquette P200)

### Comparative Sweetener B:

| Ingredient | Percent Weight (%) |
|---|---|
| Sorbidex 16616 | 44.00 |
| Eridex 16961 | 19.00 |
| Isomaltidex 165A3 | 18.90010 |
| Sta-Lite Polydextrose | 13.00 |
| Fibersol 3 Resistant | 5.00 |
| Maltodextrin | |
| Ace K | 0.094245 |
| Neotame | 0.005655 |
| Total | 100.00 |

### Preparation of Cupcakes:

Eighty (80) gram iced cupcakes were prepared in the Cargill bake lab. Each cupcake consisted of 45 grams of baked cake that was coated with 35 grams of icing. The sweetener to be tested was included in both the cake and icing portions of each cupcake in an amount shown in the recipes provided below.

### Preparation of Cake Batter:

Cake batters were prepared having the recipe shown in TABLE 1. Each cake batter was prepared from a standard yellow cake base having the ingredients shown in TABLE 2.

TABLE 1
Cake Batter Recipes

| | Cake Batter 1 | Cake Batter 2 | Cake Batter 3 |
|---|---|---|---|
| Ingredient | (wt. %) | (wt. %) | (wt. %) |
| Yellow Cake Base | 33.830 | 33.830 | 33.830 |
| (Table 2) | | | |
| Sweetener 1 | 29.300 | — | — |
| Comp Sweetener A | — | 29.300 | — |
| Comp Sweetener B | — | — | 29.300 |
| Cargill Cake and Icing | 4.920 | 4.920 | 4.920 |
| Shortening | | | |
| Water - 1^{st} addition | 17.430 | 17.430 | 17.430 |
| Water - 2^{nd} addition | 14.520 | 14.520 | 14.520 |
| Total | 100.00 | 100.00 | 100.00 |

TABLE 2
Standard Yellow Cake Base

| Ingredient | Percent Weight (%) |
|---|---|
| Cargill Cake flour | 72.864 |
| Henningsen | 7.153 |
| EggYolk Solids | |
| Dare foods NFDM | 5.646 |
| Cargill Cake and | 2.956 |
| Icing Shortening | |
| Henningsen Egg | 2.838 |
| White Solids | |
| Cargill Salt | 1.951 |
| Innnophos BL-60 | 1.756 |
| SALP | |
| Benchmate Baking | 1.753 |
| Soda | |
| Loders &Crokkaan | 1.478 |
| EC-25 Emulsifier | |
| Cargill Starch | 0.916 |
| 12643 | |
| Degusa Powdered | 0.591 |
| Vanilla | |
| Cargill Xanthan | 0.098 |
| Gum | |
| Total | 100.0 |

After baking the cupcakes, each cupcake was iced with an icing composition comprising the same sweetener that was used in the cake batter. That is, Cake Batter 1 was used with Icing Formulation 1 to provide a cupcake comprising SWEETENER 1; Cake Batter 2 was used with Icing Formulation 2 to provide a cupcake comprising COMP. SWEETENER A; and Cake Batter 3 was used with Icing Formulation 3 to provide a cupcake comprising COMP. SWEETENER B. The white icings had the recipes listed in TABLE 3.

TABLE 3
(White Icing Formulations)

| | Icing | Icing | Icing |
|---|---|---|---|
| | Formulation 1 | Formulation 2 | Formulation 3 |
| Ingredient | (wt. %) | (wt. %) | (wt. %) |
| Sweetener 1 | 57.143 | — | — |
| Comp. Sweetener A | — | 57.143 | — |
| Comp. Sweetener B | — | — | 56.604 |
| Cargill cake and icing | 28.571 | 28.571 | 28.302 |
| Shortening | | | |
| Water | 13.714 | 13.714 | 14.528 |
| Cargill Salt | 0.343 | 0.343 | 0.3396 |
| Cargill Powdered | 0.181 | 0.181 | 0.1792 |
| Vanilla #043-000775 | | | |
| Cream type Flavor # | 0.048 | 0.048 | 0.0472 |
| #060-02841 | | | |
| Total | 100.000 | 100.00 | 100.000 |

### Results:

Generally speaking, the gastrointestinal symptoms increased after consuming the cupcakes and peaked after 6 hours. The gastrointestinal symptoms generally returned to baseline after 24 hours. Significantly milder gastrointestinal symptoms were reported for several of the symptoms after consuming the cupcakes comprising SWEETENER 1 when compared to the cupcakes comprising COMP. SWEETENER A. In addition, significantly milder gastrointestinal symptoms were reported for several of the symptoms after consuming the cupcakes comprising COMP. SWEETENER B when compared to the cupcakes comprising COMP. SWEETENER A. More specifically, significantly milder gastrointestinal rumbling, abdominal cramping, abdominal gas/bloating and excessive flatulence symptoms were reported 6 hours after consumption for the cupcakes comprising SWEETENER 1 as compared to the cupcakes comprising COMP. SWEETENER A, and also as compared to the cupcakes comprising COMP. SWEETENER B. Significantly milder abdominal cramping was reported for COMP. SWEETENER B as compared to COMP. SWEETENER A at 12 hours after consumption. Significantly milder abdominal cramping was reported after 24 hours for COMP. SWEETENER A as compared to SWEETENER 1. There was no difference in any of the symptoms prior to consuming the cupcakes or two hours after consumption, and no significant difference in loose stools at any time point. A small number of participants reported having diarrhea with all three test foods. The detailed results are provided in TABLE 4.

TABLE 4
P-Values-Pairwise Treatment Comparison

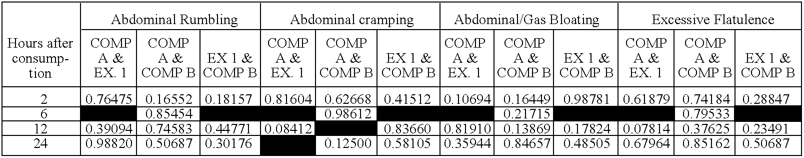

Shaded blocks identify comparisons having a significant P-value of P ≦ 0.05.

### Discussion:

The milder symptoms experienced after ingesting foods comprising SWEETENER 1 may be attributed to the composition of the sweetener. Erythritol is a better tolerated low-digestible carbohydrate as compared to maltitol because about 90% of it is absorbed in the small intestine and excreted unchanged in the urine. The remainder undergoes colonic fermentation. The resistant starch may contribute to the milder gastrointestinal symptoms in that any symptoms resulting therefrom may be experienced at a different time points and therefore not contribute to the cumulative symptoms of the polyols. In using a combination of ingredients with differing types and rates of symptoms, SWEETENER 1 was observed to be better tolerated than maltitol.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated.

What is claimed is:

1. A low calorie sweetener composition comprising: (a) about 5 wt. % to about 40 wt. % erythritol; (b) 0 wt. % to about 30 wt. % sorbitol; (c) 0 wt. % to about 50 wt. % isomalt, maltitol, or a mixture thereof; (d) about 5 wt. % to about 40 wt. % resistant starch; and (e) about 5 wt. % to about 40 wt. % polydextrose.

2. The sweetener composition of claim 1, wherein the sweetener composition further includes a high intensity sweetener.

3. The sweetener composition of claim 2, wherein the high intensity sweetener is present in an amount of about 0.4 wt. % or less.

4. The sweetener composition of claim 2, wherein the high intensity sweetener is selected from the group consisting of sucralose, acesulfame potassium, neotame, aspartame, saccharin, alitame, cyclamate, monellin, monatin and it salts, glycyrrhizin and its salts, thaumatin, stevia, compounds derived from stevia, brazzein, neohesperidin dihydrochalcone, 3,4-dihydroxybenzylamine, lo han guo, a sweetness potentiator, and mixtures thereof.

5. The sweetener composition of claim 2, wherein the high intensity sweetener comprises neotame and acesulfame potassium.

6. The sweetener composition of claim 5, wherein neotame is present in an amount of about 0.006 wt. % to about 0.011 wt. % and wherein acesulfame potassium is present in an amount of about 0.09 wt. % to about 0.18 wt. %.

7. The sweetener composition of claim 1, wherein the erythritol is present in an amount of about 25 wt. % to about 35 wt. %.

8. The sweetener composition of claim 1, wherein the sorbitol is present in an amount of about 10 wt. % to about 20 wt. %.

9. The sweetener composition of claim 1, wherein the isomalt, maltitol, or mixture thereof is present in an amount ranging from about 25 wt. % to about 35 wt. %.

10. The sweetener composition of claim 1, wherein maltitol is present in an amount ranging from about 15 wt. % to about 45 wt. %.

11. The sweetener composition of claim 1, wherein isomalt is present in an amount ranging from about 25 wt. % to about 35 wt. %.

12. The sweetener composition of claim 1, wherein the polydextrose is present in an amount ranging from about 10 wt. % to about 20 wt. %.

13. The sweetener composition of claim 1, wherein the resistant starch is present in an amount ranging from about 5 wt. % to about 20 wt. %.

14. The sweetener composition of claim 1, wherein the resistant starch is a RS1, RS2, RS3, or RS4 type resistant starch.

15. The sweetener composition of claim 1, wherein the resistant starch is an RS4 type resistant starch.

16. The sweetener composition of claim 1, wherein the resistant starch has a dextrose equivalent of about 100.

17. A food composition comprising the sweetener composition of claim 1.

18. The food composition of claim 17, wherein the food composition is a baked good, a confectionary, a dairy product, a cereal bar, a health bar, and a protein bar,

19. The food composition according to claim 17, wherein the food composition is a baked good.

20. A beverage composition comprising a beverage and the sweetener composition of claim 1.

21. The sweetener composition of claim 1, wherein the sweetener composition has improved gastrointestinal tolerance as compared to maltitol.

22. The sweetener composition of claim 1, wherein the sweetener composition has improved gastrointestinal tolerance as compared to maltitol when measured using Test Protocol 1.

23. The sweetener composition of claim 22, wherein the sweetener composition has improved gastrointestinal tolerance as compared to maltitol when measured using Protocol 1 at 6 hours.

24. A sweetener composition comprising: (a) about 25 wt. % to about 35 wt. % erythritol; (b) about 10 wt. % to about 20 wt. % sorbitol; (c) about 25 wt. % to about 30 wt. % isomalt, maltitol, or a mixture thereof; (d) about 5 wt. % to about 20 wt. % resistant starch; (e) about 10 wt. % to about 20 wt. % polydextrose; and (f) about 0.4 wt. % or less of a high intensity sweetener comprising neotame and acesulfame potassium.

25. A sweetener composition comprising: (a) about 5 wt. % to about 40 wt. % erythritol; (b) up to about 68 wt. % of an ingredient selected from isomalt, maltitol, sorbitol, or a mixture thereof; (c) about 5 wt. % to about 40 wt. % of an ingredient selected from polydextrose, resistant maltodextrin, or a mixture thereof.

26. The sweetener composition of claim 25, wherein the sweetener comprises about 29 wt. % polydextrose, about 57% maltitol, and about 14% erythritol.
